(19) United States
(12) Patent Application Publication
(10) Pub. No.: US 2005/0245693 A1
(43) Pub. Date: Nov. 3, 2005

(54) Fluorinated aromatic polymers

(76) Inventor: Sanjiv M. Bhatt, Minnetonka, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/838,125

(22) Filed: May 3, 2004

(51) Int. Cl. C08L 65/00; C08L 23/28

(52) U.S. Cl. 525/416

(57) ABSTRACT

Fluorinated polymers of interest have aromatic groups in their repeat units and at least about 25% of available aromatic ring positions fluorinated. The aromatic rings can be along the polymer backbone and/or along the side chains of the polymer. In particular, for polymers with the aromatic groups along the polymer backbone generally at least about 55 percent of the aromatic ring positions are fluorinated. Approaches for the fluorination of aromatic polymers can involve a polymer melt that is contacted with an appropriate fluorination reagent. In other approaches, the fluorination is performed in a polymer solution. The fluorination reactions can be performed in a batch operation or a continuous operation.

### FIELD OF THE INVENTION

The invention relates to fluorinated aromatic polymer compositions, generally with high levels of fluorination. The invention further relates to methods involving polymer melts of aromatic polymers for fluorinating the aromatic groups of the polymer. Also, the invention relates to solution based methods for fluorinating aromatic polymers.

### BACKGROUND OF THE INVENTION

Fluorinated polymers have found a range of commercial uses. In particular, polytetrafluoroethylene (PTFE), which is commercially sold as Teflon® and other brands, have found a wide range of uses as coatings, binders, lubricants and other products. PTFE has been found to have desirable properties for certain applications, such as resistance to corrosive chemicals and durability. Other fluorinated polymers of commercial significance include, for example, poly(vinyl fluoride) and poly(vinylidene fluoride), which are useful in protective coatings.

On the other hand, aromatic polymers have found use as plastics that can have high mechanical strengths. In particular, aromatic polycarbonates can have high impact strengths. Some aromatic polymers can be crystalline or semi-crystalline, which can contribute to the desirable mechanical properties. Also, some aromatic polymers can be processed using desirable processing approaches. For example, some desirable polymers can be processed as a melt in extrusion or molding processes to form a range of desirable forms, shapes and the like.

### SUMMARY OF THE INVENTION

In a first aspect, the invention relates to a composition comprising an aromatic polymer with aromatic side chain groups in which at least about 25 percent of the side chain aromatic ring positions are substituted with a fluorinated substituent.

In a further aspect, the invention relates to a composition comprising an aromatic polymer with aromatic backbone groups in which at least about 55 percent of the backbone aromatic ring positions are substituted with a fluorinated substituent.

In another aspect, the invention relates to a method for fluorinating an aromatic polymer based on a polymer melt. In some embodiments, the method comprises reacting a fluorinating agent with a melt of an aromatic polymer to fluorinate the polymer at positions along the aromatic ring.

In a further aspect, the invention pertains to a method for fluorinating an aromatic polymer based on a solution of the aromatic polymer. In some embodiments, the method comprises reacting a fluorinating agent with an aromatic polymer in solution to fluorinate the aromatic polymer at positions along the aromatic rings.

### DETAILED DESCRIPTION OF THE INVENTION

It has been discovered that advantageous properties of fluorinated polymers can be achieved with fluorinated aromatic polymers. In particular, as described herein, aromatic polymers have aromatic groups in the repeat units of the polymer. By the placement of fluorinated substituents onto the aromatic ring positions of the aromatic polymer, the resulting fluorinated polymer can be more resistant to chemical degradation, more inert with respect to contact with other articles and more water repellant. The aromatic nature of the polymers can contribute desirable properties to the fluorinated polymer. In particular, aromatic polymers can have high values of mechanical strength and abrasion resistance. In some embodiments, it is desirable to perform the fluorination of the polymer following polymerization. By fluorinating the polymer, a range of desirable, commercially available aromatic polymers can be selected as the starting material for fluorination. The desired properties of the fluorinated polymer can be selected both by the selection of the starting polymer as well as selecting the fluorination conditions during the polymer processing step for the formation of the fluorinated product.

In selected embodiments, the fluorination reaction is performed with a polymer melt in which shear can be applied to mix the fluorination reagent through the polymer to obtain the desired degree of fluorination. In additional or alternative embodiments, the fluorination reaction is performed in solution with a solvent that can dissolve the aromatic polymer. Articles can be formed from the fluorinated aromatic polymers. Suitable articles include, for example, carriers for sensitive articles, such as electrical components, fluid handling equipment and portions thereof, and components for electrochemical cells.

As used herein aromatic polymers have an aromatic group within the repeat unit of the polymer. An aromatic group has a ring structure with a resonance stabilization energy relating to a plurality of unsaturated chemical bonds. Aromatic groups include carbon rings and heterocyclic rings, which can include, for example, nitrogen atoms or sulfur atoms. In addition, aromatic groups can be single ring structures or polycyclic structures with more than one ring in a conjugated structure, such as bicyclic, tricyclic etc. Examples of hydrocarbon aromatic groups include, for example, phenyl, naphthyl, benzyl groups. Examples of heterocyclic aromatic groups include, for example, furanyl, thiophenyl, pyrrolyl groups. In an aromatic polymer, the aromatic group can be along the polymer backbone and/or the aromatic group can be along a polymer side chain. If an aromatic group is within the polymer backbone, the polymer backbone can further comprise linear or branched groups. In general, aromatic groups can be substituted to replace hydrogen atoms with other chemical groups, which in the present case are fluorinated. In particular, an aromatic group can be substituted as long as the aromatic nature of the ring group is not compromised.

In general, polymers have a distribution of polymer sizes/molecular weights. The polymer sizes can be characterized by an average chain size, i.e., -[X]ₙ- where X is the polymer repeat unit, which can be represented by an appropriate chemical formula, and n is a number that is an average of the distribution of integers characterizing the polymer chain length. The average chain length can alternatively be expressed in terms of an average molecular weight of the polymer. Thus, as used herein, X comprises an aromatic ring group along the polymer chain, i.e. along the polymer backbone, and/or on a side chain extending from the polymer backbone. Generally, the polymer properties depend on both the average chain size/average molecular weight and the distribution of chain sizes/molecular weights. The distribution and average chain size generally depends on the conditions used to form the polymer. It may be difficult to ascertain the distribution and average polymer chain sizes, which may only be estimated based on the properties of the polymer, such as the polymer rheology in a melt or in solution. Furthermore, commercial polymers may only be characterized roughly if the producer does not release all of the available information. Furthermore, the polymer may be crosslinked. Crosslinking involves chemical bonding between polymer chains with a corresponding increase in molecular weights. To distinguish small oligomers, the term polymer, as used herein, is presumed to have an average number of repeats (n, above) of at least 5.

The polymer compositions of particular interest have at least a portion of the aromatic ring positions substituted with a fluorinated substituent group. The fluorinated group can be simply a fluorine atom bonded to the aromatic ring, or the fluorinated group can be a more complex structure with fluorine atoms within the structure, such as a trifluoromethyl group. In some embodiments, at least about 25 percent of the available ring positions are bonded to a fluorinated group. Available ring positions are positions along the aromatic group that have bonds available that are not involved in the aromatic bonding or bonding of the polymer backbone or crosslinks. Thus, for example, a napthalene molecule C₁₀H₈ has eight available ring positions. A naphthalene group bonded in a polymer at a side chain has seven available positions since one position is required for bonding the group to the polymer to form the side chain. A naphthalene group bonded along the polymer backbone has six available positions since two positions are needed to bond the group along the polymer backbone. If an aromatic group is involved in a chemical crosslink, this also removes available aromatic ring positions. Any aromatic position that is involved in bonding of the basic polymer structure, i.e., polymer backbone or chemical crosslinks, is not considered available.

Generally, the fluorinated aromatic polymers described herein can be formed by any approach. For example, the polymers can be formed using fluorinated monomers during the formation of the polymer. However, in some embodiments, it can be desirable to fluorinate the polymer after the polymerization process. Thus, by performing the fluorination after polymerization, a large range of commercial polymers can be selected as starting materials for the fluorination reaction. The fluorination process can then focus on achieving the desired fluorination properties of the product polymer. If crosslinking is performed, it can be performed before, during or after the fluorination reaction.

The fluorination process can be performed in a polymer melt or within a polymer solution. The fluorination reagent can be combined with the polymer melt. In a polymer melt, shear can be supplied during the reaction or a portion thereof to ensure the fluorination reactants are distributed through the polymer to effectuate the desired degree of fluorination. For example, the shear can be supplied with a high shear commercial mixer or with an extruder. The fluorination reaction may or may not be combined in one continuous process with the procedure to form the final product. For example, an extruder can inject the fluorinated product formed within the extruder into a mold or the like for forming the product.

In some embodiments, the fluorination is performed in a polymer solution. Specifically, the polymer is dissolved into a suitable solvent and the fluorination reactant is added to the solution under appropriate conditions to perform the fluorination reaction. After completion of the fluorination reaction, the fluorinated polymer can be removed from the solvent or further processed into the ultimate product.

The chemical composition of the fluorination reactant determines the nature of the fluorination of the aromatic compound. In general, the fluorination reactant can be selected based on, for example, the reactivity, the composition of the fluorination product, handling issues, the nature of the fluorination process (melt based or solvent based) and cost. As an example, some fluorination reactants replace hydrogen atoms, halogen atoms and/or hydroxyl hydrogen atoms on the aromatic rings with fluorine atoms. Other reactants substitute the hydrogen atoms on the aromatic rings with fluorinated hydrocarbon groups or the like. The fluorinated hydrocarbon groups can be linear or branched alkyl groups, which may or may not comprise other functional groups, such as oxygen, sulfur, or nitrogen atoms. Similarly, the groups can comprise other halogen atoms in addition to the fluorine atoms.

The degree of fluorination generally depends on, for example, the amount of reactants, the reaction conditions and the reaction time. The processing approaches described herein generally can be used to perform any desired degree of fluorination. In some embodiments, the compositions are essentially completely fluorinated at the available aromatic ring positions.

Fluorination of the polymers generally results in a polymer product that is more resistant to chemical degradation, and has improved mechanical, physical and optical properties. Thus, products formed from the fluorinated product can be more long lasting for reuse and/or provide more protection for components associated with the product along with the polymer. In addition, the product polymer may be more transparent to visible light, which can be desirable for some applications. Due to improved performance, the articles may be reusable in some embodiments. Similarly, the fluorinated polymers generally are water/moisture resistant. The fluorinated polymers can be useful for forming products in which moisture resistance is desired. In addition, the fluorinated polymers generally are more inert to most other materials, such that sensitive compositions and corresponding articles can be contacted with the fluorinated polymers without adversely affecting the sensitive article.

A variety of articles can be formed from the fluorinated polymers described herein. Some articles are of particular interest and can have improved performance due to the properties contributed by the aromatic fluoropolymer. For example, the fluoropolymers can be advantageously incorporated into a carrier for semiconductor wafers. These carriers are designed to protect the wafers from a variety of physical and chemical assaults. Wafer carriers are described further, for example, in U.S. Pat. No. 6,520,338 to Bores et al., entitled “Wafer Carrier Having A Low Tolerance Build-Up,” incorporated herein by reference. In addition, some fluid handling systems are designed to handle corrosive compositions. For these systems, it can be desirable to use inert fluorinated aromatic polymers. For example, a quick connect fill system for corrosive liquids is described further in U.S. Pat. No. 6,497,260 to Hennan et al., entitled “Quick Connect Fill System,” incorporated herein by reference. Similarly, some components of electrochemical cells, such as batteries, electrolyzers and fuel cells, can be formed from polymer materials. Since some of these components either moderate water flow, such as in a fuel cell, or are resistant to water, water management can be significant function for the polymer material. The components of an electrochemical cell may or may not be electrically conductive. Electrical conductivity can be introduced into the polymers with a conductive filler, such as metal powders or conductive carbon powders, for example, graphite or carbon black. Suitable electrochemical cell components include, for example, electrodes or fuel cell bipolar plates. Fuel cell components are described further, for example, in U.S. Pat. No. 6,555,262 to Kaiser et al., entitled “Wicking Strands For A Polymer Electrolyte Membrane,” incorporated herein by reference.

Fluoropolymer Compositions

The aromatic fluoropolymers described herein have an aromatic group within the polymer repeat unit. The properties of the polymer can be selected to provide desired properties to the particular product. Similarly, the degree of fluorination can be selected to balance various factors, such as properties of the polymer and processing considerations. Within the constraints on the polymer structure with respect to the aromaticity and the fluorination, a wide range of polymers can be formed with fluorination as described herein.

The basic polymer structure can correspond to any of a range of fundamental polymer structures. With respect to suitable polymers with aromatic side chains, suitable polymers include, for example, polystyrene, which is a vinyl polymer with phenyl side groups. Suitable polymers with aromatic polymer backbones include, for example, polyimides, polysulfones, polyethersulfones, polyarylsulfones, polysulfides, polyetheretherketones, polyetherketone, polyetherketoneketone, poly(phenylene oxide), poly(phenylene sulfide), polyetherimide, aromatic polyesters, such as polycarbonate and poly(ethylene terephthalate), copolymers thereof and mixtures thereof. A wide range of these polymers and other suitable polymers are commercially available. For appropriate embodiments, these polymers can then be used as starting materials for the fluorination process.

In general, the properties of the fluorinated polymer relate to the properties of the polymer starting material as well as the fluorination process. The properties of fluoronated polymer generally are selected based on the nature of the ultimate product. For structural products, in general the polymer is selected to have a sufficient average molecular weight to provide an appropriate mechanical strength, while for other products a lower molecular weight polymer may be suitable. Thus, in some embodiments, the polymers have an average molecular weight of at least about 200 Daltons, in other embodiments at least about 500 and in additional embodiments at least about 750 Daltons. On the other hand, for some embodiments, the average molecular weight is generally at least about 10,000 Daltons, and in further embodiments at least about 25,000 Daltons, in further embodiments at least about 50,000 Daltons and in other embodiments from about 75,000 Daltons to about 5,000,000 Daltons. Also, the degree of aromaticity in the polymer influences the polymer properties. Some aromatic polymers can form crystalline structures. In general, polymers of particular interest have aromatic rings in the repeat units corresponding to at least about 10 weight percent of the repeat unit, in some embodiments at least about 20 weight percent and in further embodiments at least about 40 weight percent of the repeat unit corresponding to aromatic rings. A person of ordinary skill in the art will recognize that other molecular weight ranges and weight percent ranges within the explicit ranges are contemplated and are within the present disclosure.

As noted above, the aromatic polymers can be fluorinated on the aromatic rings in several possible ways. For example, hydrogen atoms bonded to the aromatic carbon atoms can be replaced with fluorinated moieties. The nature of the fluorinated substituent depends on the nature of the fluorinated reactant. In some embodiments, a hydrogen atom can be replaced with a fluorine atom bonded directly to the aromatic carbon. In other embodiments, a ring substituent is modified or replaced with a fluorine containing substituent, such as a fluorinated carbon containing group.

In general, the degree of fluorination depends on the fluorination reaction. The degree of fluorination can be expressed as a percentage of the aromatic ring positions that have a fluorine-containing substituent. As described above, available aromatic ring positions are counted as aromatic carbon atoms that are not involved in bonding to the polymer structure either within the polymer backbone, along chemical crosslinks or in a bond to another aromatic group. In some embodiments, essentially all of the available aromatic ring positions are bonded with a fluorinated substituent, which implies that at least about 95% of the available ring positions are fluorinated. In some embodiments, at least about 25% of the available ring positions are fluorinated, while in additional embodiment at least about 35%, in further embodiments at least about 50%, in some embodiments at least about 55%, in other embodiments at least about 60% and in additional embodiments at least about 75% of the available ring positions are fluorinated. A person of ordinary skill in the art will recognize that additional ranges of fluorination within the explicit ranges are contemplated and are within the present disclosure.

Fluorination Reagents

The chemical composition of the fluorination reaction determines the substituent that is placed on the aromatic ring. Specifically, some fluorination reagents can replace a hydrogen atom on the ring with a fluorine atom. Other reagents replace a hydrogen atom with a fluorine containing substituent bonded to the aromatic carbon atom. Still other reagents are reactive with respect to other aromatic substituents, such as halogens or hydroxyl groups.

With respect to fluorinating agents that place a fluorine atom on the aromatic ring, HF and F₂ are effective compounds to fluorinate the aromatic ring with a fluorine atom. Fluorine F₂ is a gas that is extremely reactive as an oxidizing agent. Due to the violent reactive nature of fluorine gas, the reaction must be carefully moderated to fluorinate the aromatic ring without disintegrating the polymer molecule. HF is a very strong acid that is soluble in water. HF in its pure state is a gas.

Other reagents add a fluorine containing group to the aromatic ring. For example, fluorocarbon iodides can add to the aromatic ring to substitute the fluorocarbon moiety for the fluorocarbon. The carbon chain bound to the aromatic ring may be saturated or unsaturated and may be linear, branched or cyclic. The fluorocarbon iodide may or may not be perfluonated such that they do not contain any hydrogren atoms. For example, trifluoromethyl iodide (CF₃I), perfluoroethyliodide (CF₅I), perfluoroisopropyl iodide (C₃F₇I) and perfluoropropyliodide (C₃F₇I) as well as many other suitable compounds are available from Aldrich Chemical, Milwaukee, Wis. Other suitable alkylating agents include, for example, fluorinated peroxides, such as bisperfluoroalkylperoxide.

Other fluorocarbon reactants can add a fluorine containing group to appropriate aromatic polymers. For example, poly-phenols with a phenol ring along the backbone or in a side-chain in which the ring is fluoronated through the hydroxyloxygen. Suitable fluorination reagents include, for example, chlorodifluoromethane (DuPont) fluoro-olefins, such as tetrafluoroethylene and hexafluoropropylene (both available from DuPont) or perfluorovinylether. Perfluoromethylvinylether, perfluoroethylvinylether and perfluoropropylvinylether are available from DuPont. For polyarylhalides, the halide group on the aromatic ring is reactive with methyl 2-(fluorosulfonyl)difluoroacetate (DuPont) to introduce a —CF₃ group onto the aromatic ring.

Melt-Based Processing Approaches

Melt based processing approaches can be based on polymer melts performed in a heated apparatus generally with the application of shear. In general, the fluorinating agent can be added initially or after the polymer is melted, and the fluorinating agent can be added at once or gradually over time. However, it can be desirable to add the fluorinating to the melted polymer gradually. The reaction can be performed in suitable commercial processing equipment. The amount of reactants, reaction time and reaction conditions can be selected to achieve the desired level of fluorination.

Suitable equipment includes, for example, heated mixers and extruders. In particular, suitable mixers include, for example, a Buss Kneader K 600 CP (Davy Process Technoloty AG, Switzerland), a Ring Extruder from Century Inc. (Traverse City, Mich.), a Banbury mixer (Farrel Corp., Ansonia, Conn.), or a Thermo Hakke twin blade mixer (Haake Instruments, Paramus, N.J.). A single screw extruder or multi-screw extruder, such as a twin screw extruder, can be used. Multi-screw extruders can have the advantage of providing better mixing within the extruder. Similarly, suitable commercial extruders include, for example, a Berstorff model ZE or KE extruders (Hannover, Germany), Leistritz model ZSE or ESE extruders (Somerville, N.J.) and Davis-Standard mark series extruders (Pawcatuck, Conn.). The fluorinating reagent can be added to the polymer melt through a port in the reactor/extruder, and shear can be applied to mix the fluorinating agent through the polymer melt to achieve relatively uniform fluorination through the mass of the polymer. In an extruder, the polymer can be introduced from a hopper into the extruder. The fluorinating agent can be added through a port to the melted polymer moving through the extruder. For example, HF can be introduced into the extruder as a gas, while a perfluoroalkyliodide or a bisperfluoroalkylperoxide generally can be added into the extruder as liquids or as solutions. The location of the port, the speed of movement of the polymer through the extruder, the temperature of the extruder, and the rate of adding the fluorinating agent can be selected to achieve desired results of the fluorination reaction.

The fluorinated polymer is dispensed through the extruder outlet. A die can be placed at the extruder outlet to shape the form of the extruded polymer. The shaped polymer can be further calendered, molded or the like to form an article or a raw material to form an article using any of the polymer conversion processes, such as compression molding, transfer molding and injection molding to name a few. For example to form a coating, the polymer can be calendered into a thin sheet that is then laminated to another structure such as a polymer form. Similarly, if the fluorination is performed in a high shear mixer, the polymer can be transferred to other processing equipment to form the polymer into a desired form.

Solution-Based Processing Approaches

In solution based processes, the polymer is dissolved into a solution. The fluorinating agent can then be added into the solution as a gas or as a liquid/solution. For example, HF gas can be bubbled into the solution or dissolved into an appropriate solvent. A perfluoroalkyliodide or bisperfluoroalkylperoxide generally can be added as a liquid or as a solution. Commercial reactors can be used to perform the reaction. In some embodiments, it is desirable to apply mixing to the solution during the reaction.

The fluorination reaction in solution can be performed either in batch or continuous processing. Suitable apparatuses are available for either type of processing. For example, for continuous solution based processes, the polymer solution is transported from a reservoir through the reactor to an outlet. The fluorination reactant can be combined with the polymer solution as it is added to the reactor, or it can be added to the flowing polymer solution through an appropriate port. Suitable apparatuses for continuous fluorination processing include, for example, a Buss Kneader K 600 CP (Davy Process Technology AG, Switzerland) or a ring extruder (Century Inc., Traverse City, Mich.). For batch operation, all of the reactants can be combined in the solution, or the fluorination reactant can be added gradually over time. Some suitable reactors have temperature control to control the reaction at an appropriate temperature range for the reaction. In some embodiments, suitable bench scale synthesis can be performed with a flask and a heating/cooling mantle.

In general, the polymer is dissolved in the solution at suitable concentrations in which the polymer can be well dispersed. The selection of the solvent depends on the nature of the polymer and the fluorination reactant. In general, aromatic polymers may be soluble in appropriate organic solvents, such as aromatic solvents. The suppliers generally provide appropriate information on the solvents for processing a particular polymer. Mixtures of solvents can be used to facilitate incorporation of both the polymer and the fluorination reagent.

The amounts of reactants as well as the reaction time and reaction conditions can be used to control the degree of fluorination. Assuming that the reactions are allowed to go to completion and the materials are properly mixed, the degree of fluorination can be controlled solely based on the amounts of reactants. The degree of mixing can be controlled to achieve a desired amount of uniformity of the fluorination of the aromatic rings.

Some of the fluorination reactions are exothermic. The rate of reaction generally increases with increasing temperature. If too much heat is generated, it may be desirable to cool the reaction to control the reaction rate. On the other hand, if the reaction is progressing too slowly, it may be desirable to heat the reaction. In general, a person of ordinary skill in the art can adjust the amount of reactants, the reaction time and the reaction conditions to obtain a desired result.

After fluorination of the polymer, the polymer can be further processed into the final product. In particular, the polymer can be further processed in solution, or the solvent can be removed, for example, by evaporation, to yield the polymer, which can be further processed in a melt. The polymer solution can be concentrated to provide a desired amount of viscosity for further processing, such as by molding, calendering, extruding or the like. The remaining solvent can be removed following formation of the final product.

For comparison with the approaches described herein, the fluorination of aliphatic polymers and silicon based polymers is described in the article “Synthesis of fluoronated polymers by chemical modification,” by Reisinger and Hillmyer, Progress in Polymer Science, 27 (2002) 971-1005, incorporated herein by reference.

The embodiments described above are intended to be illustrative and not limiting. Additional embodiments are within the claims. Although the present invention has been described with reference to particular embodiments, workers skilled in the art will recognize that changes may be made in form and detail without departing from the spirit and scope of the invention.

1. A composition comprising an aromatic polymer with aromatic backbone groups in which at least about 55 percent of the backbone aromatic ring positions are substituted with a fluorinated substituent.

2. The polymer composition of claim 1 wherein the polymer is selected from the group consisting of polycarbonate, polyimide, polyetherether ketone, polyetherimide, polyethersulphone, polyphenylene sulphide, polyetherketone, polyetherketoneketone, copolymers thereof and mixtures thereof.

3. The polymer composition of claim 1 wherein the polymer further comprises aromatic groups in the polymer side chains.

4. The polymer composition of claim 1 wherein at least about 60 percent of the aromatic ring positions are substituted with a fluorinated substituent.

5. The polymer composition of claim 1 wherein at least about 75 percent of the aromatic ring positions are substituted with a fluorinated substituent.

6. The polymer composition of claim 1 wherein essentially all of the aromatic ring positions are fluorinated.

7. The polymer composition of claim 1 wherein the fluorinated substituent comprises a fluorine atom substituent.

8. The polymer composition of claim 1 wherein the fluorinated substituent comprises a fluorinated alkyl group.

9. The polymer composition of claim 1 wherein the fluorinated substituent comprises a trifluoromethyl group.

10. The polymer composition of claim 1 wherein the fluorinated substituent comprises a pentafluoroethyl group.

11. The polymer composition of claim 1 wherein the aromatic group makes up at least about 10 weight percent of the polymer repeat unit.

12. A composition comprising an aromatic polymer with aromatic side-chains in which at least about 25 percent of the side-chain aromatic ring positions are substituted with a fluorinated substituent.

13. The composition of claim 12 wherein the polymer comprises polystyrene.

14. The polymer composition of claim 12 wherein at least about 55 percent of the aromatic ring positions are substituted with a fluorinated substituent.

15. The polymer composition of claim 12 wherein the polymer further comprises aromatic groups along the polymer backbone.

16. The polymer composition of claim 12 wherein essentially all of the aromatic ring positions are fluorinated.

17. The polymer composition of claim 12 wherein the fluorinated substituent comprises a fluorine atom substituent.

18. The polymer composition of claim 12 wherein the fluorinated substituent comprises a fluorinated alkyl group.

19. A method for fluorinating an aromatic polymer, the method comprising reacting a fluorinating agent with a melt of an aromatic polymer to fluorinate the polymer at positions along the aromatic ring.

20. The method of claim 19 wherein shear is applied during at least a portion of the reaction step.

21. The method of claim 20 wherein the shear is applied with an extruder.

22. The method of claim 21 wherein the fluorinating agent is added through a port in the extruder a distance from the extruder die.

23. The method of claim 20 wherein the shear is applied in a mixer and further comprising injection molding the fluorinated polymer.

24. The method of claim 19 wherein the polymer has aromatic groups along the polymer backbone.

25. The method of claim 19 wherein the polymer is selected from the group consisting of polycarbonate, polyimide, polyetherether ketone, polyetherimide, polyethersulphone, polyphenylene sulphide, polystyrene, polyetherketone, polyetherketoneketone, copolymers thereof and mixtures thereof.

26. The method of claim 19 wherein the fluorinating agent comprises HF.

27. The method of claim 19 wherein the fluorinating agent comprises perfluoroalkyl iodide.

28. The method of claim 19 wherein the fluorinating agent comprises bisperfluoroalkylperoxide.

29. The method of claim 19 wherein the fluorinated polymer has at least about 25 percent of the positions on the aromatic ring substituted with a fluorinated substituent.

30. The method of claim 19 wherein the reacting process is performed in a batch mode.

31. The method of claim 19 wherein the reacting process is performed in a continuous mode.

32. A method for fluorinating an aromatic polymer, the method comprising reacting a fluorinating agent with an aromatic polymer in solution to fluorinate the aromatic polymer at positions along the aromatic rings.

33. The method of claim 32 wherein the solution comprises an organic liquid.

34. The method of claim 33 wherein the organic liquid comprises an aromatic solvent.

35. The method of claim 32 wherein the fluorinating agent is added gradually to the solution during mixing of the solution.

36. The method of claim 32 wherein the temperature of the solution is controlled within a selected range.

37. The method of claim 32 wherein the fluorinating agent comprises HF.

38. The method of claim 32 wherein the fluorinating agent comprises perfluoroalkyl iodide.

39. The method of claim 32 wherein the fluorinating agent comprises bisperfluoroalkylperoxide.

40. The method of claim 32 wherein the aromatic polymer has aromatic groups along the polymer backbone.

41. The method of claim 32 wherein the polymer is selected from the group consisting of polycarbonate, polyimide, polyetherether ketone, polyetherimide, polyethersulphone, polyphenylene sulphide, polystyrene, polyetherketone, polyetherketoneketone, copolymers thereof and mixtures thereof.

42. The method of claim 32 wherein the fluorinated polymer has at least about 25 percent of the positions on the aromatic ring substituted with a fluorinated substituent.

43. The method of claim 32 wherein the reacting process is performed in a batch operation.

44. The method of claim 32 wherein the reacting process is performed in a continuous operation.
